(19) United States
(12) Patent Application Publication
(10) Pub. No.: US 2023/0036958 A1
(43) Pub. Date: Feb. 2, 2023

(54) DISPLAY CONTROL SYSTEM, WORK MACHINE, AND DISPLAY CONTROL METHOD

(71) Applicant: Komatsu Ltd., Tokyo (JP)

(72) Inventors: Akira TANISHIGE, Tokyo (JP); Junki IRIE, Tokyo (JP); Daiki ARIMATSU, Tokyo (JP); Koichi SHIMA, Tokyo (JP)

(21) Appl. No.: 17/768,544

(22) PCT Filed: Nov. 5, 2020
(86) PCT No.: PCT/JP2020/041289

§ 371 Date: Apr. 13, 2022

(30) Foreign Application Priority Data
Nov. 5, 2019 (JP) 2019-201037

(51) Int. Cl. G05D 1/02; E02F 9/26

(52) U.S. Cl. CPC G05D 1/0278; E02F 9/264; E02F 9/261

(57) ABSTRACT

A display control system includes a GNSS reception unit configured to receive position information from a GNSS controller, a display signal generation unit configured to generate a signal for displaying guidance information of a work machine based on the position information, a power signal reception unit configured to receive a power-off signal, and a shutdown processing unit configured to perform a shutdown process after a predetermined time has elapsed from receiving the power-off signal.

### TECHNICAL FIELD

The present disclosure relates to a display control system, a work machine, and a display control method.

Priority is claimed on Japanese Patent Application No. 2019-201037, filed Nov. 5, 2019, the content of which is incorporated herein by reference.

### BACKGROUND ART

Patent Document 1 discloses an input control method of a touch panel monitor for a work machine capable of allowing display on a monitor screen and preventing an erroneous operation input on a touch panel.

### CITATION LIST

### Patent Document

### Patent Document 1

Japanese Unexamined Patent Application, First Publication No. 2015-202841

### SUMMARY OF INVENTION

### Problems to be Solved by the Invention

There is known a display control device attached to a driver's seat of a work machine to assist an operation of an operator by displaying a state of the work machine. Normally, the display control device is powered on and activated together with key-on of the work machine, that is, activation of the engine, and is powered off together with key-off of the work machine, that is, stop of the engine.

As an example, the display control device may be configured to start up itself, and then perform a start-up of a GNSS controller. The GNSS controller is a device for acquiring a global position of the work machine based on a satellite signal. Normally, the GNSS controller receives signals from multiple satellites to perform an initialization immediately after activation. The initialization may take about several minutes depending on the reception status of the satellite signal.

For example, when having a conversation with other workers around a site, an operator of the work machine temporarily keys off the work machine. In such a case, not only the work machine but also the display control device and the GNSS controller are turned off according to the key-off operation. Then, even when a key-on operation is performed immediately after the conversation is finished, since the activation of the display control device, the GNSS controller, and the initialization of the GNSS controller are executed, it takes time for the monitor to be able to display a normal process.

For the above-mentioned problems, it is conceivable to perform a power-off operation independently for the display control device regardless of the key-off operation of the work machine. However, in a case where the operator who has finished the work of the day forgets to turn off the power of the display control device after stopping the engine of the work machine, there is a problem in that the power-on state of the display control device is maintained and the battery of the work machine is consumed.

In view of the above-mentioned problems, the present disclosure discloses a display control system, a work machine, and a display control method capable of immediately displaying a monitor during a normal process in a case where the work machine is temporarily keyed off and then keyed on again.

### Solution to Problem

According to one aspect of the present disclosure, a display control system includes a GNSS reception unit configured to receive position information from a GNSS controller, a display signal generation unit configured to generate a signal for displaying guidance information of a work machine based on the position information, a power signal reception unit configured to receive a power-off signal, and a shutdown processing unit configured to perform a shutdown process after a predetermined time has elapsed from receiving the power-off signal.

### Advantageous Effects of Invention

According to the above aspect, in a case where the work machine is temporarily keyed off and then keyed on again, it is possible to immediately display a monitor during a normal process.

### BRIEF DESCRIPTION OF DRAWINGS

FIG. 1 is a view showing an overall configuration of a work machine according to a first embodiment.

FIG. 2 is a view showing a configuration of a cab of the work machine according to the first embodiment.

FIG. 3 is a diagram for explaining a flow of a signal related to a power source according to the first embodiment.

FIG. 4 is a diagram for explaining a flow of a signal related to a power source according to the first embodiment, which is a diagram for explaining part of the configuration shown in FIG. 3 in more detail.

FIG. 5 is a view showing an example of guidance information displayed on an ICT monitor according to the first embodiment.

FIG. 6 is a diagram showing a functional configuration of the ICT monitor according to the first embodiment.

FIG. 7 is a diagram showing a process flow of the ICT monitor according to the first embodiment.

FIG. 8 is a view showing an example of guidance information displayed on the ICT monitor according to the first embodiment.

FIG. 9 is a view showing an example of a guidance setting menu displayed on the ICT monitor according to the first embodiment.

FIG. 10 is a view for explaining a function of a setting change unit according to the first embodiment.

FIG. 11 is a view showing an operation example of the ICT monitor according to another embodiment.

### DESCRIPTION OF EMBODIMENTS

<First Embodiment>

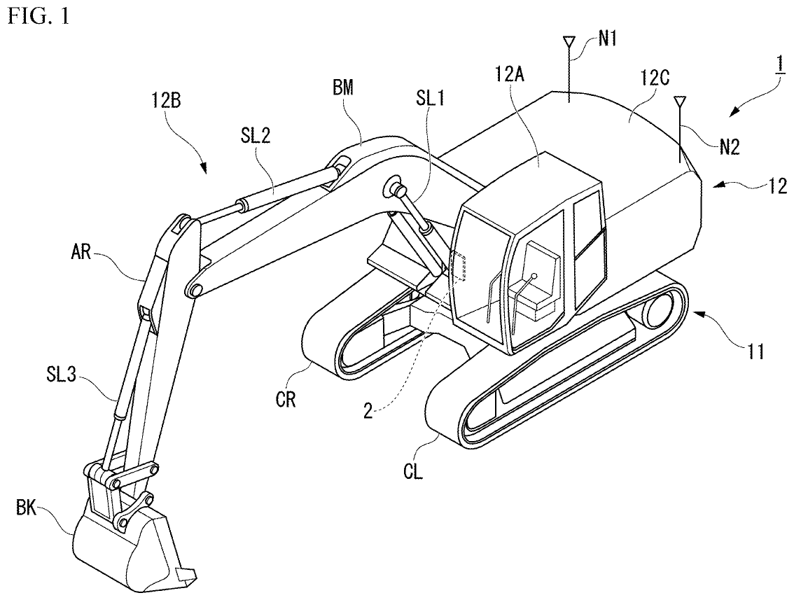

Hereinafter, a display control system and a work machine provided with the display control system according to a first embodiment will be described in detail with reference to FIGS. 1 to 10.

(Structure of Work Machine)

FIG. 1 is a view showing a structure of a work machine according to the first embodiment.

A work machine 1, which is a hydraulic excavator, excavates and levels the earth and the like at a work site or the like.

As shown in FIG. 1, the work machine 1, which is a hydraulic excavator, includes an undercarriage 11 for traveling and an upper swing body 12 provided on an upper portion of the undercarriage 11 being capable of swinging around an axis in a vertical direction. In addition, the upper swing body 12 is provided with a cab 12A, work equipment 12B, and two GNSS antennas N1 and N2.

The undercarriage 11 includes a left crawler track CL and a right crawler track CR. The work machine 1 moves forward, turns, and moves backward by the rotation of the left track CL and the right track CR.

The cab 12A is a place where an operator of the work machine 1 gets on board to perform operation and driving. The cab 12A is provided, for example, at a left side portion of a front-end portion of the upper swing body 12. An ICT monitor 2 is mounted in the cab 12A of the work machine 1. The ICT monitor 2 is an example of the display control device.

The work equipment 12B includes a boom BM, an arm AR, and a bucket BK. The boom BM is mounted at the front-end portion of the upper swing body 12. In addition, the arm AR is attached to the boom BM. In addition, the bucket BK is attached to the arm AR. In addition, a boom cylinder SL1 is attached between the upper swing body 12 and the boom BM. The boom BM can operate with respect to the upper swing body 12 by driving the boom cylinder SL1. An arm cylinder SL2 is attached between the boom BM and the arm AR. The arm AR can operate with respect to the boom BM by driving the arm cylinder SL2. A bucket cylinder SL3 is attached between the arm AR and the bucket BK. The bucket BK can operate with respect to the arm AR by driving the bucket cylinder SL3.

The foregoing upper swing body 12, boom BM, arm AR, and bucket BK included in the work machine 1, which is a hydraulic excavator, are one of aspects of a movable portion of the work machine 1.

Although the work machine 1 according to the present embodiment has been described to include the foregoing configurations, in another embodiment, the work machine 1 does not necessarily include all of the foregoing configurations.

(Configuration of Cab)

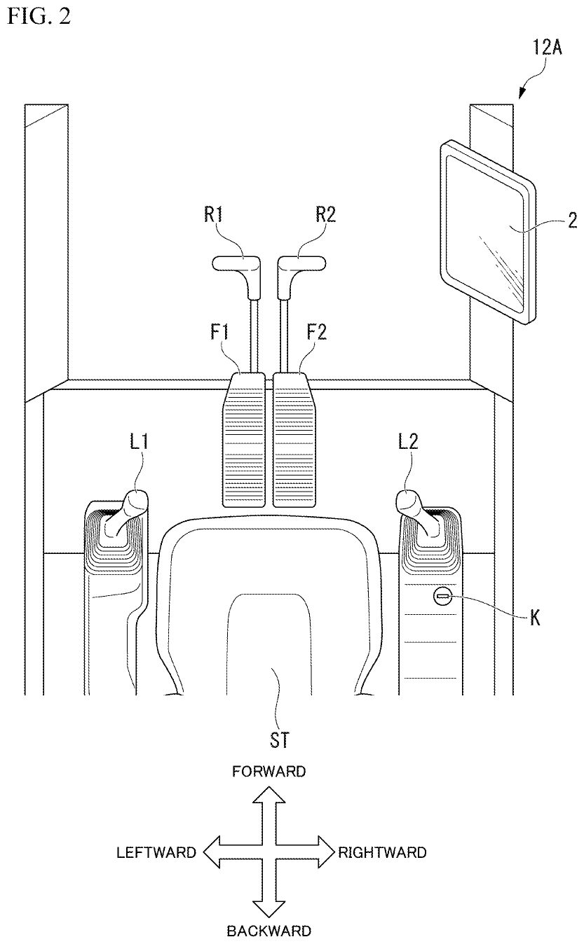

FIG. 2 is a view showing a configuration of a cab of the work machine according to the first embodiment.

As shown in FIG. 2, the cab 12A is provided with operating levers L1 and L2, foot pedals F1 and F2, and travel levers R1 and R2.

The operating lever L1 and the operating lever L2 are disposed at left and right sides of a seat ST in the cab 12A. In addition, the foot pedal Fl and the foot pedal F2 are disposed on a floor surface in front of the seat ST in the cab 12A.

The operating lever L1 disposed at the left side when facing the front of the cab is an operating mechanism for performing a swing operation of the upper swing body 12 and an excavating and dumping operation of the arm AR. In addition, the operating lever L2 disposed at the right side when facing the front of the cab is an operating mechanism for performing an excavating and dumping operation of the bucket BK and a raising and lowering operation of the boom BM.

In addition, the travel levers R1 and R2 are operating mechanisms for performing an operation control of the undercarriage 11, that is, a traveling control of the work machine 1. The travel lever R1 disposed at the left side when facing the front of the cab corresponds to a rotational drive of the left crawler track CL of the undercarriage 11. The travel lever R2 disposed at the right side when facing the front of the cab corresponds to a rotational drive of the right crawler track CR of the undercarriage 11. Furthermore, the foot pedals Fl and F2 are each interlocked with the travel levers R1 and R2 and the traveling control can be performed by the foot pedals Fl and F2.

A vehicle body key K is provided at a right side of the seat ST. The operator performs a key-on operation and a key-off operation using the vehicle body key K.

The ICT monitor 2 is provided at a front right side when facing the front of the cab. Hereinafter, a function of the ICT monitor 2 will be described in detail. Furthermore, in another embodiment, the ICT monitor 2 may be provided at a front left side or the like when facing the front of the cab.

(Flow of Signals Related to Power Source)

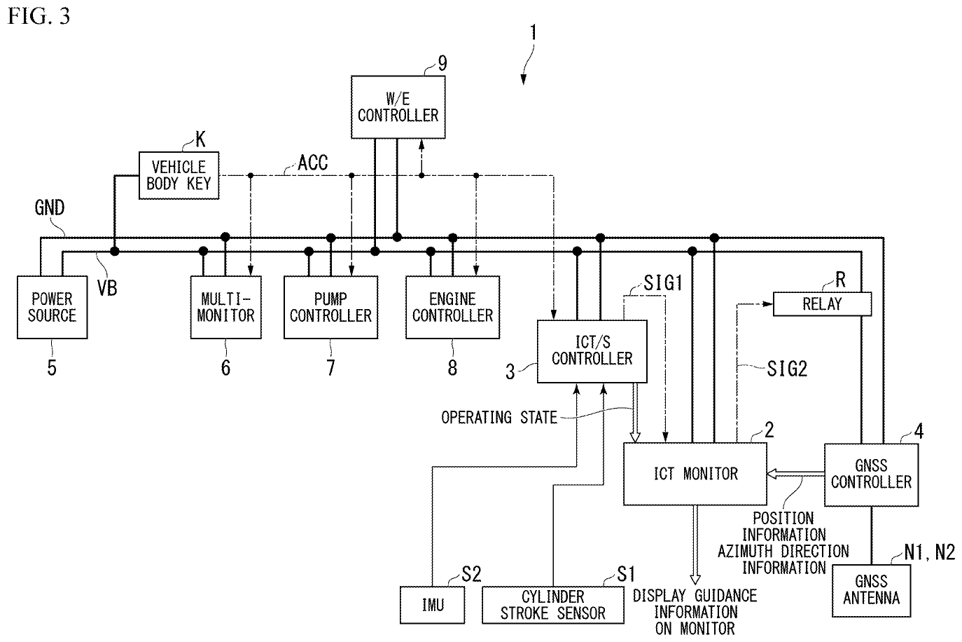

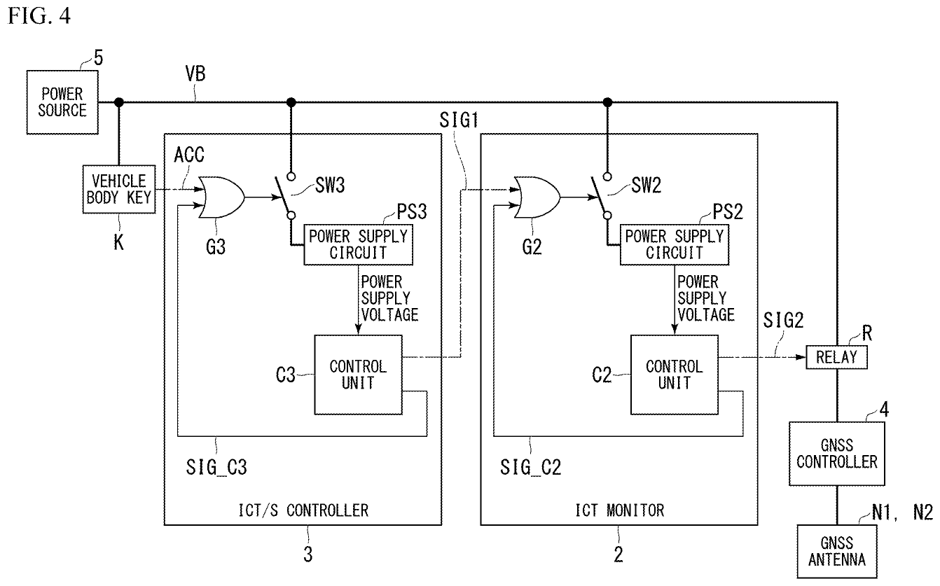

FIGS. 3 and 4 are diagrams for explaining a flow of a signal related to a power source according to the first embodiment. FIG. 4 is a diagram for explaining part of the configuration shown in FIG. 3 in more detail.

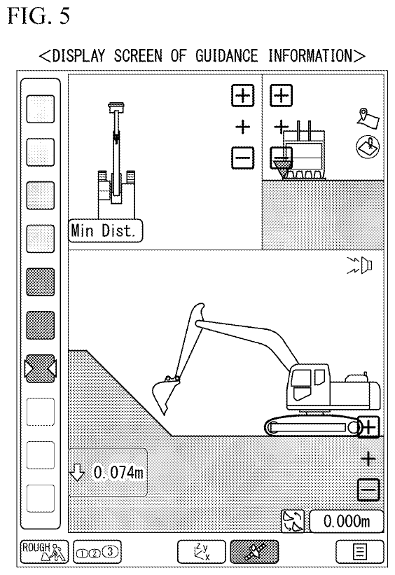

In addition, FIG. 5 is a view showing an example of guidance information displayed on an ICT monitor according to the first embodiment.

As shown in FIG. 3, the work machine 1 includes the ICT monitor 2, an ICT/S controller 3, a GNSS controller 4, a power source 5, a multi-monitor 6, a pump controller 7, an engine controller 8, and a W/E controller 9.

The ICT monitor 2 provides guidance information to the operator of the work machine 1. The guidance information is information that visually indicates an operating state of a vehicle body (described later), a position and an azimuth direction on a design surface of the work machine 1, a position of teeth of the bucket BK, and the like. The operating state of the vehicle body is, for example, a posture of the work machine 1, a swing position of the upper swing body 12, posture angles of the boom BM, the arm AR, the bucket BK, and the like. The operating state of the vehicle body may be information including any one of the posture of the work machine 1, the swing position of the upper swing body 12, the posture angles of the boom BM, the arm AR, and the bucket BK, or any combination thereof. The ICT monitor 2 generates guidance information based on the operating state of the vehicle body received from the ICT/S controller 3, position information and azimuth direction information received from the GNSS controller 4, and outputs the guidance information to a monitor 22.

Furthermore, in the work machine 1 according to another embodiment, it is also possible to generate guidance information without using the operating state of the vehicle body. In addition, in the work machine 1 according to another embodiment, it is also possible to generate guidance information without using the azimuth direction information of the vehicle body.

An example of a display screen of the guidance information is shown in FIG. 5.

The ICT/S controller 3 acquires various information from a cylinder stroke sensor Si and an inertial measurement unit (IMU) S2, and calculates the operating state of the vehicle body of the work machine 1. Here, the various information is specifically a degree of extension of each cylinder obtained from the cylinder stroke sensor Si as well as an acceleration and an angular velocity obtained from the inertial measurement unit S2. Furthermore, the ICT/S controller 3 is an example of a vehicle body controller.

The cylinder stroke sensor S1 is attached to each of the boom cylinder SL1, the arm cylinder SL2, and the bucket cylinder SL3 shown in FIG. 1 to be capable of measuring the degree of extension of each cylinder. In addition, the inertial measurement unit S2 is installed at various places of the upper swing body 12 and the work equipment 12B in the work machine 1 to be capable of measuring the acceleration and the angular velocity at the installation places.

The ICT/S controller 3 calculates a posture angle of the work equipment 12B based on the degree of extension of each cylinder acquired from the cylinder stroke sensor S1. In addition, the ICT/S controller 3 calculates a vehicle body tilt angle such as a pitch angle and a swing angle based on the acceleration and the angular velocity acquired from the inertial measurement unit S2. Hereinafter, the above-mentioned various information calculated by the ICT/S controller 3 is collectively referred to as an operating state of the vehicle body.

The ICT/S controller 3 transmits the calculation result of the operating state of the vehicle body to the ICT monitor 2 and the W/E controller 9 (described later).

The GNSS controller 4 acquires absolute positions of the GNSS antennas N1 and N2 in a global coordinate system based on satellite signals received from the GNSS antennas N1 and N2. The GNSS controller 4 acquires position information indicating an absolute position of the work machine 1 in the global coordinate system based on the absolute positions of the two antennas N1 and N2. For example, the GNSS controller 4 calculates an intermediate position between the absolute positions of the two antennas N1 and N2 as the absolute position of the work machine 1.

In addition, the GNSS controller 4 calculates the azimuth direction of the work machine 1 in the global coordinate system based on a relative positional relationship between the two GNSS antennas N1 and N2. For example, the GNSS controller 4 calculates a straight line connecting the absolute positions of the two GNSS antennas N1 and N2 and calculates an azimuth direction of the work machine 1 based on an angle formed by the calculated straight line and a predetermined reference azimuth direction.

The GNSS controller 4 transmits the position information indicating the absolute position of the work machine 1 and the azimuth direction information indicating the azimuth direction of the work machine 1 to the ICT monitor 2. Furthermore, in another embodiment, it may have an aspect that the GNSS controller 4 transmits the absolute positions of the antennas N1 and N2 to the ICT monitor 2, and the ICT monitor 2 calculates the absolute position and azimuth direction of the work machine 1 based on the two absolute positions.

In addition, in a case where an azimuth direction sensor is mounted on the work machine 1 in another embodiment, the ICT monitor 2 may have an aspect that azimuth direction information is acquired through the azimuth direction sensor.

A predetermined operating voltage is supplied to the GNSS antennas N1 and N2 from the GNSS controller 4.

The multi-monitor 6 is a monitor that displays various instruments that indicate states such as fuel level and coolant temperature.

The pump controller 7 controls an output of a hydraulic pump. The hydraulic pump is mechanically connected to the engine and is driven by the driving of the engine to discharge hydraulic oil to hydraulic devices such as the boom cylinder SL1.

The engine controller 8 controls an amount of fuel supplied to the engine to control an output of the engine.

The W/E controller 9 acquires the operating state of the vehicle body from the ICT/S controller 3 to control the vehicle body of the work machine 1. For example, the W/E controller 9 may calculate a distance between a teeth tip of the bucket BK and a target design surface from the operating state of the vehicle body acquired from the ICT/S controller 3 and output an intervention command according to the distance. The intervention command is, for example, a command to reduce a moving speed of the work equipment as a tip of the bucket teeth approaches the target design surface or the like. In addition, other control of the vehicle body may be performed. Furthermore, in another embodiment, control of the vehicle body of the work machine 1 may not be performed.

Furthermore, the ICT/S controller 3 and the W/E controller 9 may be configured integrally. In addition, the ICT monitor 2 and the multi-monitor 6 may be configured integrally. Furthermore, a controller in which the ICT/S controller 3 and the W/E controller 9 are integrally configured is an example of the vehicle body controller.

The power source 5 is a battery mounted as a constant power source of the work machine 1. The power source 5 supplies, for example, a DC power supply voltage of 24 V to each of the above-mentioned controllers through a power supply line VB and a ground line GND.

As shown in FIG. 3, when the vehicle body key K is key-on, a power-on signal ACC is transmitted from the vehicle body key K to each of the ICT/S controller 3, the multi-monitor 6, the pump controller 7, the engine controller 8, and the W/E controller 9. Upon receiving this power-on signal ACC, each controller starts activation based on the DC power supply voltage supplied from the power source 5.

In addition, a power-on signal SIG1 from the ICT/S controller 3 that has been activated is input to the ICT monitor 2. When the power-on signal SIG1 from the ICT/S controller 3 is input, the ICT monitor 2 starts activation based on the DC power supply voltage supplied from the power source 5.

In addition, a relay R is inserted into the power supply line VB connecting between the power source 5 and the GNSS controller 4. A power-on signal SIG2 from the ICT monitor 2 that has been activated is input to the relay R. When the power-on signal SIG2 is input to the relay R, the relay R is turned on to enable a connection between the power source 5 and the GNSS controller 4. Accordingly, the GNSS controller 4 starts activation based on the DC power supply voltage from the power source 5. That is, the GNSS controller 4 is activated by the power-on signal SIG2 from the ICT monitor 2.

FIG. 4 shows part of an internal configuration of the ICT/S controller 3 and the ICT monitor 2. As shown in FIG. 4, the ICT/S controller 3 has a switch SW3, a power supply circuit PS3, a control unit C3, and an OR gate G3 thereinside. Similarly, the ICT monitor 2 has a switch SW2, a power supply circuit PS2, a control unit C2, and an OR gate G2 thereinside.

First, the internal configuration of the ICT/S controller 3 will be described. The power-on signal ACC generated by a key-on operation of the vehicle body key K is input to the switch SW3 via the OR gate G3 of the ICT/S controller 3. The switch SW3 is turned on in response to an input of the power-on signal ACC. Accordingly, the power supply circuit PS3 is connected to the power supply line VB, and the DC power supply voltage from the power source 5 is supplied to the power supply circuit PS3. The power supply circuit PS3 converts the DC power supply voltage from the power source 5 into an appropriate power supply voltage, and inputs the converted power supply voltage to the control unit C3. Accordingly, the control unit C3 is activated. The control unit C3 is, for example, a CPU or the like that performs a main process of the ICT/S controller 3.

The control unit C3 turns on a self-power-on signal SIG C3 during activation and inputs the self-power-on signal SIG C3 to the OR gate G3. With this configuration, even when the power-off signal ACC is suddenly transmitted due to the key-off operation of the operator, power supply to the control unit C3 can be prevented from being immediately cut off. The OR gate G3 is a so-called self-holding circuit and is used to secure time for transferring memory data to a non-volatile memory due to the power-off of the control unit

C3.

Furthermore, the OR gate G3 and the switch SW3 are implemented from discrete components such as transistors.

Furthermore, the multi-monitor 6, the pump controller 7, the engine controller 8, and the W/E controller 9 have the same power supply circuit, self-holding circuit, and the like as those of the ICT/S controller 3.

Next, the internal configuration of the ICT monitor 2 will be described.

The power-on signal SIG1 from the ICT/S controller 3 is input to the switch SW2 via the OR gate G2 of the ICT monitor 2. The switch SW2 is turned on in response to the input of the power-on signal SIG1. Accordingly, the power supply circuit PS2 is connected to the power supply line VB, and the DC power supply voltage from the power source 5 is supplied to the power supply circuit PS2. The power supply circuit PS2 converts the DC power supply voltage from the power source 5 into an appropriate power supply voltage to input the converted power supply voltage to the control unit C2. Accordingly, the control unit C2 is activated.

The control unit C2 is, for example, a CPU or the like that performs a main process of the ICT monitor 2. The control unit C2 inputs a self-power-on signal SIG C2 to the OR gate G2 during activation. With this configuration, even when a sudden power-off signal SIG1 is transmitted from the ICT/S controller 3, power supply to the control unit C2 can be prevented from being immediately cut off. The OR gate G2 is a so-called self-holding circuit and is used to secure time for transferring memory data to a non-volatile memory due to the power-off of the control unit C2.

Furthermore, the OR gate G2 and the switch SW2 are implemented from discrete parts such as transistors.

(Flow After Key-On Operation)

A flow after a key-on operation will be described in detail with reference to FIGS. 3 and 4.

First, when the vehicle body key K is keyed on by the operator while the work machine 1 is stopped, the engine of the work machine 1 is operated. At the same time, the power-on signal ACC is simultaneously transmitted from the vehicle body key K to the ICT/S controller 3, the multi-monitor 6, the pump controller 7, the engine controller 8, and the W/E controller 9.

When the power-on signal ACC is received from the vehicle body key K, the switch SW3 is turned on to activate the ICT/S controller 3 based on the DC power supply voltage supplied from the power source 5. When the activation is completed, the control unit C3 of the ICT/S controller 3 transmits the power-on signal SIG1 to the ICT monitor 2. After that, the control unit C3 of the ICT/S controller 3 acquires the operating state of the vehicle body through the cylinder stroke sensor S1 and the inertial measurement unit S2 as a steady operation and transmits the operation state to the ICT monitor 2.

When the power-on signal SIG1 is received from the ICT/S controller 3, the switch SW2 is turned on to activate the ICT monitor 2 based on the DC power supply voltage supplied from the power source 5. When the activation is completed, the control unit C2 of the ICT monitor 2 transmits the power-on signal SIG2 toward the relay R. Then, the relay R is turned on, and the GNSS controller 4 is connected to the power supply line VB. Accordingly, the GNSS controller 4 is activated based on the DC power supply voltage supplied from the power source 5.

When the activation of the GNSS controller 4 is completed, the ICT monitor 2 can acquire the position information and the azimuth direction information from the GNSS controller 4. The ICT monitor 2 generates guidance information based on the position information and the azimuth direction information received from the GNSS controller 4, and the operating state of the vehicle body received from the ICT/S controller 3 and displays the guidance information on the monitor.

The GNSS controller 4 performs an initialization when the activation is completed. After that, the GNSS controller 4 acquires the position information and the azimuth direction information based on satellite signals and transmits the acquired information to the ICT monitor 2.

(Flow after Key-off Operation)

Next, a flow after the key-off operation will be described in detail.

When the vehicle body key K is keyed off by the operator while the work machine 1 is activated, the engine of the work machine 1 is stopped. At the same time, the power-off signal ACC is transmitted from the vehicle body key K to the ICT/S controller 3.

When the power-off signal ACC is received from the vehicle body key K, the ICT/S controller 3 performs a shutdown process to turn off the power after a predetermined period. In addition, the control unit C3 of the ICT/S controller 3 transmits the power-off signal SIG1 to the ICT monitor 2 before the power is turned off. Furthermore, in a case where the power of the ICT/S controller 3 is turned off, the operating state is not transmitted to the ICT monitor 2. That is, the operating state of the vehicle body is not updated on the ICT monitor 2. In addition, a display indicating a distance between a design surface and a bucket teeth position may be blank or may not be updated.

The power-off signal SIG1 input to the ICT monitor 2 is received by the control unit C2 inside the ICT monitor 2.

When the power-off signal SIG1 is received from the ICT/S controller 3, the control unit C2 inside the ICT monitor 2 performs a shutdown process to turn off the power after a predetermined time has elapsed from the time when the power-off signal SIG1 is received.

In addition, when the power-off signal SIG1 is received from the ICT/S controller 3, the control unit C2 outputs a power-off signal SIG2 after a predetermined time has elapsed from the reception time of the power-off signal SIG1. The details of these processes will be described later.

When the power-off signal SIG2 is received from the ICT monitor 2, the GNSS controller 4 performs a shutdown process to turn off the power after a predetermined period.

(Functional Configuration of ICT Monitor 2)

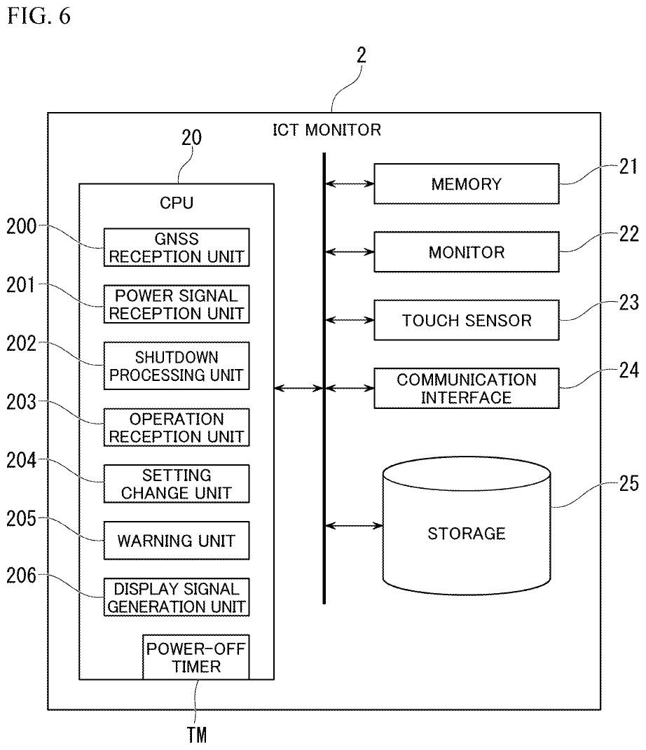

FIG. 6 is a diagram showing a functional configuration of the ICT monitor 2 according to the first embodiment.

As shown in FIG. 6, the ICT monitor 2 includes a CPU 20, a memory 21, a monitor 22, a touch sensor 23, a communication interface 24, and a storage 25. Furthermore, the CPU 20 may be in any form such as a FPGA, a GPU, or the like as long as it is similar thereto.

The CPU 20 is a processor that controls an overall operation of the ICT monitor 2. Various functions included in the CPU 20 will be described later.

The memory 21 is a so-called main storage device. Instructions and data necessary for the CPU 20 to operate based on a program are deployed in the memory 21.

The monitor 22, which is a display panel capable of visually displaying information, is, for example, a liquid crystal display, an organic EL display, or the like. Guidance information is displayed on the monitor 22.

The touch sensor 23 is an input device integrally formed with the monitor 22 and specifying a position of an image displayed on the monitor 22. Furthermore, the ICT monitor 2 according to another embodiment may have an aspect that is provided with another input device corresponding to the touch sensor 23, such as a mouse or a keyboard.

The communication interface 24 is a communication interface for communicating between the ICT monitor 2 and an external server.

The storage 25 is a so-called auxiliary storage device, for example, a hard disk drive (HDD), a solid-state drive (SSD), or the like.

Next, the functions included in the CPU 20 will be described in detail. The CPU 20 operates based on a predetermined program, thereby exerting as functions of a GNSS reception unit 200, a power signal reception unit 201, a shutdown processing unit 202, an operation reception unit 203, a setting change unit 204, a warning unit 205, and a display signal generation unit 206.

Furthermore, the predetermined program may implement some of the functions exerted by the ICT monitor 2. For example, the program may exert a function in combination with another program already stored in the storage 25, or in combination with another program mounted on another device. Furthermore, in another embodiment, the ICT monitor 2 may include a custom large scale integrated circuit (LSI) such as a programmable logic device (PLD) in addition to or in place of the above configuration. Examples of PLDs include a programmable array logic (PAL), a generic array logic (GAL), a complex programmable logic device (CPLD), and a field programmable gate array (FPGA). In this case, some or all of the functions implemented by the processor may be implemented by the integrated circuit.

The GNSS reception unit 200 acquires position information and azimuth direction information from the GNSS controller 4.

The power signal reception unit 201 receives the power-on signal SIG1 and the power-off signal SIG1 from the ICT/S controller 3.

The shutdown processing unit 202 performs a shutdown process after a predetermined time has elapsed from receiving the power-off signal SIG1. For example, the shutdown processing unit 202 transmits the power-off signal SIG2 to the GNSS controller 4 in response to the power-off signal SIG1 received from the ICT/S controller 3. In addition, the power of the ICT monitor 2 is turned off in response to the power-off signal SIG1. In particular, in a case where the power-off signal SIG1 is received from the ICT/S controller 3, the shutdown processing unit 202 may transmit the power-off signal SIG2 after a predetermined time has elapsed from the reception time. In addition, the power supply of the ICT monitor 2 may be turned off by turning off an output of the OR gate G2 and an output of the power supply circuit PS2 after a predetermined time has elapsed from the reception time.

The operation reception unit 203 receives a touch operation from the operator through the touch sensor 23. The operation reception unit 203 according to the present embodiment can receive an operation related to the display of guidance information during the elapse of the predetermined time.

The setting change unit 204 changes the predetermined time based on the operation of the operator.

The warning unit 205 warns the operator in a case where the power of the ICT/S controller 3 is turned off.

The display signal generation unit 206 generates a display signal indicating an image to be displayed on the monitor 22.

In addition, the CPU 20 has a built-in power-off timer TM having a timer function. The power-off timer TM may be in an aspect of software in which the CPU 20 operating according to the program exerts its function or may be in an aspect of hardware configured with a logic circuit or the like. In addition, in another embodiment, the power-off timer TM may have an aspect that is installed outside the CPU 20.

(Process Flow of ICT Monitor)

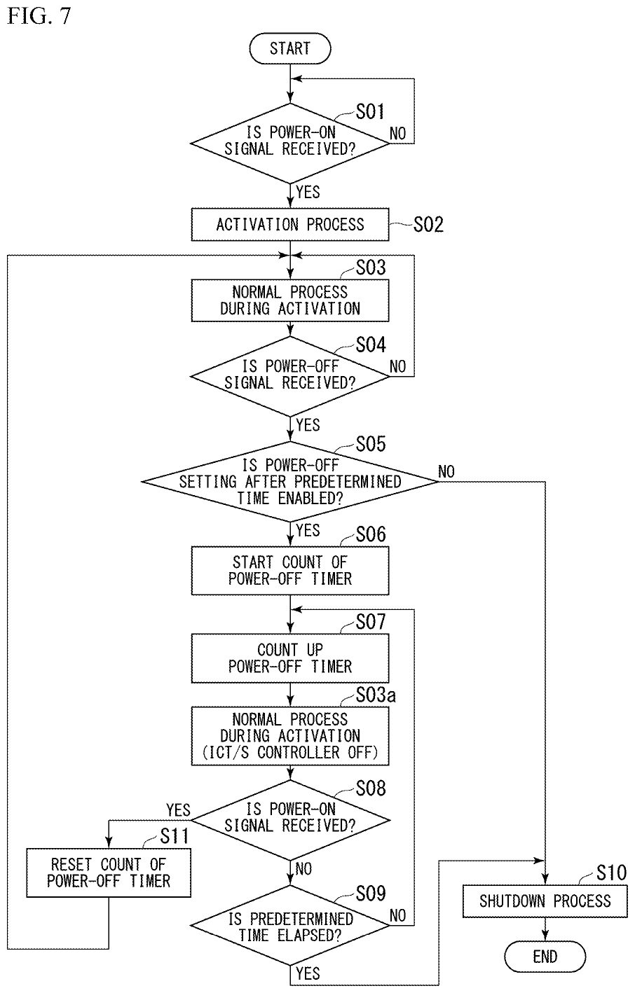

FIG. 7 is a diagram showing a process flow of the ICT monitor according to the first embodiment.

The process flow shown in FIG. 7 is executed from a step before the key-on operation is made by the operator, that is, from a power-off state.

First, the ICT monitor 2 in the power-off state is waiting for the power-on signal SIG1 from the ICT/S controller 3 (step S01).

When the power-on signal SIG1 is received from the ICT/S controller 3 (step S01; YES), the ICT monitor 2 performs an activation process (step S02). In the activation process of step S02, the ICT monitor 2 transmits the power-on signal SIG2 to the GNSS controller 4.

Accordingly, the GNSS controller 4 also starts activation.

When the activation process is completed, a normal process during activation is executed (step S03). The normal process during activation is a general process in which the ICT monitor 2 provides guidance information (FIG. 5) to the operator. For example, the ICT monitor 2 updates a display screen of guidance information based on the position information and the operating state of the vehicle body that change from moment to moment according to the operation of the work machine 1. In addition, the operation reception unit 203 of the ICT monitor 2 performs a change in a display format of the guidance information, a change in a number of screen divisions, a change of a background color, and the like, based on a touch operation of the operator related to the display of the guidance information received via the touch sensor 23. Furthermore, a screen that is displayed based on the position information of the GNSS controller 4, such as a screen that displays the position of the work machine 1, a screen that shows a time series of the position of the work machine 1, or the like, is also guidance information.

Furthermore, the ICT monitor 2 can execute the process of step S03 as described above after the position information and the azimuth direction information can be steadily received from the GNSS controller 4. Therefore, the ICT monitor 2 waits until the initialization of the GNSS controller 4 is completed in the activation process (step S02).

The shutdown processing unit 202 of the ICT monitor 2 determines whether or not the power-off signal SIG1 has been received from the ICT/S controller 3 (step S04).

In a case where the power-off signal SIG1 has not been received from the ICT/S controller 3 (step S04; NO), the ICT monitor 2 returns to step S03 to repeatedly execute a process during activation.

In a case where the power-off signal SIG1 is received from the ICT/S controller 3 (step S04; YES), the shutdown processing unit 202 determines whether or not a setting for turning off the power after a predetermined time from receiving the power-off signal SIG1 (hereinafter, also referred to as a power-off setting after a predetermined time) is enabled (step S05).

When the power-off setting after a predetermined time is disabled (step S05; NO), the shutdown processing unit 202 proceeds to a shutdown process of step S10 in order to immediately turn off the power of the ICT monitor 2.

When the power-off setting after a predetermined time is enabled (step S05; YES), the shutdown processing unit 202 starts the count of the power-off timer TM in order to turn off the power of the ICT monitor 2 after a predetermined time has elapsed (step S06).

The shutdown processing unit 202 counts up the power-off timer TM (step S07).

In addition, the ICT monitor 2 executes a process substantially equivalent to the normal process during activation in step S03 even during the count-up of the power-off timer TM (step S03a). However, since the power of the ICT/S controller 3, which is a higher-level device, is turned off at this point, the process is different from that of step S03 in this respect. The details of the process in step S03a will be described later.

The shutdown processing unit 202 determines whether or not the power-on signal SIG1 has been received from the ICT/S controller 3 (step S08).

In a case where the power-on signal SIG1 has not been received from the ICT/S controller 3 (step S08; NO), the shutdown processing unit 202 then determines whether or not the count of the power-off timer TM has reached a predetermined time (step S09).

In a case where the count of the power-off timer TM has not reached the predetermined time (step S09; NO), the shutdown processing unit 202 returns to step S07 to continue the count-up of the power-off timer TM.

In a case where the count of the power-off timer TM reaches the predetermined time (step S09; YES), the shutdown processing unit 202 executes a shutdown process in order to turn off the power of the ICT monitor 2 (step S10). In the shutdown process, the ICT monitor 2 transmits the power-off signal SIG2 to the GNSS controller 4. Accordingly, the power of the GNSS controller 4 is also turned off

On the other hand, when the power-on signal SIG1 is received from the ICT/S controller 3 during the count-up of the power-off timer TM (step S08; YES), the shutdown processing unit 202 resets the count of the power-off timer (step S11), and returns to the process of step S03. That is, the shutdown process can be prohibited without executing the shutdown process. Here, since the initialization of the GNSS controller 4 does not need to be performed again, the ICT monitor 2 can shorten the time required to enable the normal process.

Furthermore, in the above-mentioned process flow, an aspect in which the measurement of a predetermined time is performed by a method of counting up the power-off timer TM has been described, but another embodiment is not limited to the aspect. In the measurement of the predetermined time, a method of counting down the power-off timer TM may be used, and other well-known methods of time measurement may be applied.

Furthermore, step S01, step S02, steps S05 to S07, step S03a, and step S11 in the process flow described with reference to FIG. 7 are not essential components, and such steps may not be included in another embodiment.

(Process of ICT Monitor in Case Where ICT/S Controller is in Power-off State)

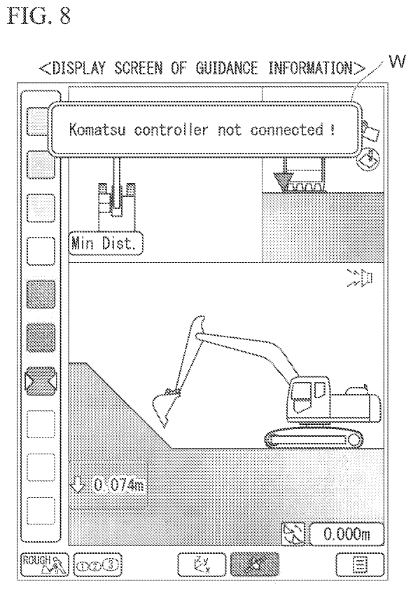

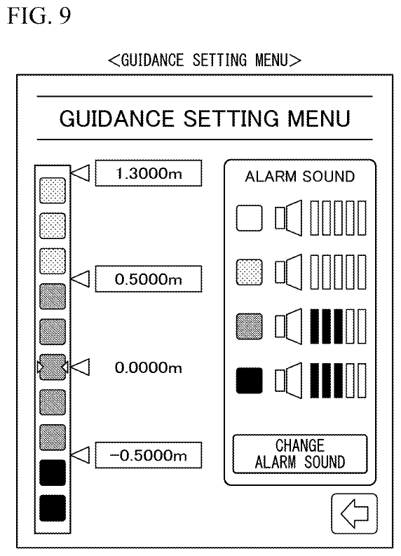

FIG. 8 is a view showing an example of guidance information displayed on the ICT monitor according to the first embodiment. In addition, FIG. 9 is a view showing an example of a guidance setting menu displayed on the ICT monitor according to the first embodiment.

In the normal process during activation in step S03a, unlike the normal process during activation in step S03, the power is turned off after a predetermined time after the shutdown process of the ICT/S controller 3. Therefore, in step S03a, the ICT monitor 2 does not receive the operating state of the vehicle body from the ICT/S controller 3 after the power-off of the ICT/S controller 3. For that reason, the ICT monitor 2 is not updated from the operating state of the vehicle body last received from the ICT/S controller 3. In this case, the ICT monitor 2 maintains a display screen of guidance information based on the operating state of the vehicle body last received from the ICT/S controller 3.

In a case where the power of the ICT/S controller 3 is turned off, the warning unit 205 of the ICT monitor 2 displays a warning display K on the monitor 22. For example, as shown in FIG. 8, the warning display K is displayed so as to be superimposed on the display screen of guidance information. The warning display K may have an aspect that is displayed only while the guidance information is displayed and is not displayed in a case where a display screen other than the guidance information, such as a guidance setting menu, is displayed as shown in FIG. 9. In addition, in another embodiment, the warning display K may have an aspect that is displayed in common on all display screens.

In still another embodiment, an aspect of warning by the warning unit 205 is not limited to the display of the warning display K on the monitor 22, and may be, for example, playing a warning sound to a speaker or a combination thereof.

Furthermore, the operation reception unit 203 of the ICT monitor 2 receives an input operation from the operator even in step S03a in which the power of the ICT/S controller 3 is turned off, as in step S03. For example, in step S03a, the operation reception unit 203 performs a change in a display format of the guidance information, a change in a number of screen divisions, a change of a background color, and the like, in addition to the display of the guidance setting menu as shown in FIG. 9, based on a touch operation of the operator received via the touch sensor 23.

In this way, the operation reception unit 203 can receive an operation related to the display of guidance information even during the elapse of the predetermined time. Furthermore, in the case of displaying a screen that displays information generated based on the operating state of the vehicle body received from the ICT/S controller during the lapse of the predetermined time, the information may be displayed to be blank. In addition, the display of a bucket replacement screen or a setting screen may be prohibited during the elapse of the predetermined time.

(Function of Setting Change Unit)

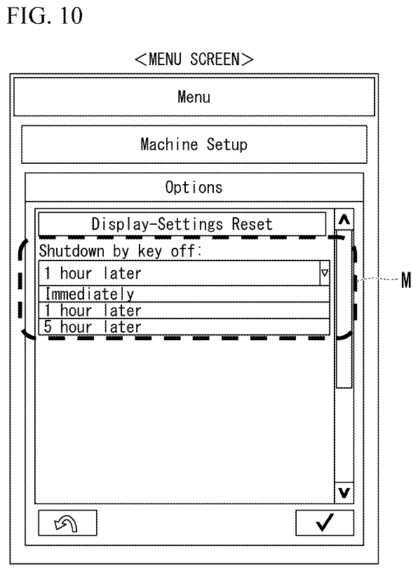

FIG. 10 is a view for explaining a function of a setting change unit according to the first embodiment.

The setting change unit 204 of the ICT monitor 2 displays a menu screen as shown in FIG. 10 in a case where a predetermined operation is received from the operator during the normal process in step S03 or step S03a. On the menu screen, a setting input form M for designating a time from receiving a key-off operation until the power of the ICT monitor 2 is turned off is displayed. In an example shown in FIG. 10, the setting change unit 204 can be selected from three items of “Immediately”, “1 hour later”, and “5 hour later”. In a case where the inputs of “1 hour later” or “5 hour later” is received, the setting change unit 204 respectively sets the predetermined time used for the determination in step S09 of FIG. 7 to 1 hour or 5 hours. In a case where the input of “Immediately” is received, the setting change unit 204 disables the power-off setting after a predetermined time. Accordingly, in step S05 of FIG. 7, a determination of no is made, and the process proceeds to the shutdown process after receiving the key-off operation. Furthermore, in a case where a predetermined time is set in step S03a, the count time of the power-off timer TM may be updated to the set predetermined time.

In addition, a process of changing the predetermined time by the setting change unit 204 may be automatically performed by software control or the like without being based on the operation of the operator.

(Operation, Effect)

As described above, the ICT monitor 2 according to the first embodiment includes a GNSS reception unit 200 configured to receive position information and azimuth direction information from a GNSS controller, a power signal reception unit 201 configured to receive the power-on signal SIG1 and the power-off signal SIG1, and a shutdown processing unit 202 configured to perform a shutdown process after a predetermined time has elapsed from receiving the power-off signal SIG1.

According to such a configuration, the display of the ICT monitor 2 is maintained in a case where the work machine is temporarily keyed off and then keyed on again.

Accordingly, the ICT monitor 2 can immediately display the monitor during a normal process.

(Another Embodiment)

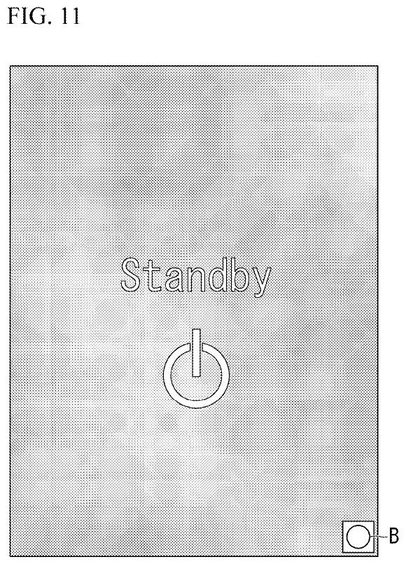

FIG. 11 is a view showing an operation example of the ICT monitor according to another embodiment.

It has been described such that the operation reception unit 203 of the ICT monitor 2 according to the first embodiment can receive an operation related to the display of guidance information during the elapse of a predetermined time by the power-off timer (TM), that is, while the power of the ICT/S controller 3 is turned off. However, another embodiment is not limited to the above aspect.

The operation reception unit 203 according to another embodiment may have a configuration that does not receive an operation related to the display of guidance information, for example, during the elapse of the predetermined time, that is, while the power of the ICT/S controller 3 is turned off. In this case, the ICT monitor 2 may further display a standby screen as shown in FIG. 11, for example. With this configuration, it may allow the operator to visually recognize that an operation related to the display of guidance information is not received.

In addition, an immediate power-off button B may be displayed on the standby screen. In a case where a touch of the immediate power-off button B is received, the ICT monitor 2 may immediately proceed to the shutdown process without waiting for the elapse of a predetermined time by the power-off timer TM.

Procedures of the above-described various processes in the ICT monitor 2 are stored on a computer-readable recording medium in the form of a program, and a computer reads and executes the program so as to perform the various processes. In addition, the computer-readable recording medium refers to a magnetic disk, a magneto-optical disk, a CD-ROM, a DVD-ROM, a semiconductor memory or the like. In addition, this computer program may be distributed to a computer through a communication line, and the computer receiving the distribution may execute the program.

The above program may implement part of the above-described functions. Moreover, the program may also be a so-called difference file, a difference program or the like capable of implementing the above-described functions through a combination with a program that is already recorded in a computer system.

As described above, several embodiments of the present disclosure have been described, but the embodiments are presented as only examples, and thus are not intended to limit the scope of the disclosure. The embodiments can be implemented in other various forms, and various omissions, replacements, and changes can be made without departing from the gist of the disclosure. The embodiments or modifications thereof are included in the disclosure disclosed in the claims and the equivalent scope thereof as included in the scope and the gist of the disclosure.

In the above-described embodiment, the work machine 1 has been described as a hydraulic excavator, but in another embodiment, it can be applied to various work machines such as a dump truck, a wheel loader, and a bulldozer.

In addition, in the above-described embodiment, it has been described that one ICT monitor 2 is provided in the work machine 1, but in another embodiment, part of the configuration of the ICT monitor 2 may be disposed in another display control device so as to be implemented by a display control system configured with two or more display control devices. Furthermore, the ICT monitor 2 according to the foregoing embodiment is also an example of the display control system.

In addition, the ICT monitor 2 according to the foregoing embodiment has been described as being provided in the work machine, but in another embodiment, part or the entirety of the configuration of the ICT monitor 2 may be provided outside the work machine.

In addition, the ICT monitor 2 according to the above-described embodiment has a monitor and causes the monitor to display a display screen, but another embodiment is not limited thereto. For example, the ICT monitor 2 according to another embodiment may not include the monitor 22, and may transmit a signal to display a display image on a monitor that is separate from the ICT monitor 2.

In addition, the ICT monitor 2 according to another embodiment may be implemented from a system configured with a monitor that is separate from the ICT monitor 2, and two or more display control devices including each part of the configuration of the ICT monitor 2 according to the first embodiment.

In addition, in the above-described embodiment, a monitor has been described as being provided in the work machine, but in another embodiment, the monitor may be provided outside the work machine. For example, the monitor may be provided at a point away from a work site, and the ICT monitor 2 may transmit a signal that displays a display screen on the monitor via a network, such as the Internet, or wireless communication.

In addition, in the above-described embodiment, it has been described such that the ICT monitor 2 performs a shutdown process; however, in another embodiment, a configuration such as the power signal reception unit 201, the shutdown processing unit 202, and the setting change unit 204 of the ICT monitor 2 may be provided in another controller such as the ICT/S controller 3 and the engine controller 8, and the shutdown process may be performed by the other controller. The shutdown process may shut down only the GNSS controller 4.

In addition, in the above-described embodiment, it has been described such that the shutdown processing unit 202 transmits the power-off signal SIG2 to turn off the power of the GNSS controller 4 after a predetermined time has elapsed; however, in another embodiment, the GNSS controller 4 may be powered off by turning off a power source and an internal signal disposed at an upstream side of the GNSS controller 4. For example, the GNSS controller 4 may be powered off by turning off the outputs of the power supply circuit PS2, the power supply circuit PS3, the switch SW2, the switch SW3, the power source 5, and the like.

In addition, in the above-described embodiment, it has been described such that the shutdown processing unit 202 turns off the power of the ICT monitor 2 by turning off an output of the OR gate G2 and an output of the power supply circuit PS2 after a predetermined time has elapsed; however, in another embodiment, the power supply of the ICT monitor 2 may be powered off by turning off a power source and an internal signal at an upstream side of the ICT monitor 2. For example, the ICT monitor 2 may be powered off by turning off the outputs of the power supply circuit PS3, the power source 5, the switch SW3, and the like.

### INDUSTRIAL APPLICABILITY

According to the above disclosure, in a case where the work machine is temporarily keyed off and then keyed on again, it is possible to immediately display a monitor during a normal process.

### REFERENCE SIGNS LIST

1: Work machine

2: ICT monitor

20: CPU

200: GNSS reception unit

201: Power signal reception unit

202: Shutdown processing unit

203: Operation reception unit

204: Setting change unit

205: Warning unit

206: Display signal generation unit

21: Memory

22: Monitor

23: Touch sensor

24: Communication interface

25: Storage

3: ICT/S controller

4: GNSS controller

5: Power source

6: Multi-monitor

7: Pump controller

8: Engine controller

9: W/E controller

1. A display control system comprising:
a global navigation satellite system (GNSS) reception unit configured to receive position information from a GNSS controller;
a display signal generation unit configured to generate a signal for displaying guidance information of a work machine based on the position information;
a power signal reception unit configured to receive a power-off signal; and
a shutdown processing unit configured to perform a shutdown process after a predetermined time has elapsed from receiving the power-off signal.

2. The display control system according to claim 1, wherein the shutdown process includes shutting down the GNSS controller.

3. The display control system according to claim 1,
wherein the power signal reception unit receives a power-on signal, and
the shutdown processing unit prohibits the shutdown process in a case where the power-on signal is received before the predetermined time elapses.

4. The display control system according to claim 1, further comprising:
an operation reception unit configured to receive an operation related to a display of the guidance information during the elapse of the predetermined time.

5. The display control system according to claim 1, further comprising:
a warning unit configured to generate a signal for displaying a warning in a case where the guidance information is displayed during the elapse of the predetermined time.

6. The display control system according to claim 1, further comprising:
a setting change unit configured to change the predetermined time.

7. A work machine comprising the display control system according to claim 1.

8. A display control method comprising:
receiving position information from a global navigation satellite system (GNSS) controller;
generating a signal for displaying guidance information of a work machine based on the position information;
receiving a power-off signal; and
performing a shutdown process after a predetermined time has elapsed from receiving the power-off signal.
